(19) United States
(12) Patent Application Publication
(10) Pub. No.: US 2006/0189722 A1
(43) Pub. Date: Aug. 24, 2006

(54) Use of aramid fiber conjunction with thermoplastic to improve wash-off resistance and physical properties such as impact and expansion

(75) Inventor: Jihong Kye, Troy, MI (US)

Correspondence Address: Richard W. Hoffmann, PO Box 70098, Rochester Hills, MI, 48307, US

(73) Assignee: Dow Global Technologies Inc., Midland, MI (US)

(21) Appl. No.: 11/341,773

(22) Filed: Jan. 27, 2006

Related U.S. Application Data
(60) Provisional application No. 60/648,237, filed on Jan. 28, 2005.

(51) Int. Cl. C08L 63/00

(52) U.S. Cl. 523/440

(57) ABSTRACT

One-part epoxy adhesive formulations, and methods of using the same, are described. The formulations include, among other things, powdered methacrylate butadiene styrene and aramid pulp to, among other things, improve the wash off resistance, T peel strength, and impact strength characteristics thereof. Additionally, the formulations exhibit desirable expansion characteristics. The formulations are especially suitable for use in joining automotive components.

### CROSS-REFERENCE TO RELATED APPLICATION

The instant application claims priority to U.S. Provisional Patent Application Ser. No. 60/648,237, filed Jan. 28, 2005, the entire specification of which is expressly incorporated herein by reference.

### FIELD OF THE INVENTION

The present invention relates generally to epoxy adhesives, and more particularly to new and improved one-part epoxy adhesive formulations having improved wash-off resistance, T peel strength, and impact strength characteristics, with low expansion characteristics.

### BACKGROUND OF THE INVENTION

With respect to the automotive industry, epoxy adhesives, including one-part, two-part, hot melt, and/or the like, have been used to bond stamped metal parts together, as well as SMC (i.e., sheet molded compound) to SMC, or SMC to metal (e.g., steel) parts for automotive assembly purposes. Typical automotive applications of one-part adhesives can include the bonding of SMC parts such as doors, hoods, tailgates and body panels. Accordingly, the use of these epoxy adhesives has enabled automotive manufacturers to reduce the weight of vehicles, as well as realize cost and labor savings by eliminating the need for other more expensive and complicated joining methods.

However, conventional epoxy adhesives typically have poor wash-off resistance, T-peel strength, and impact strength, as well as unsatisfactory expansion characteristics. For example, automotive manufacturers using conventional epoxy adhesives have experienced problems such as dripping along the assembly line and wash-off during the various wash cycles. Other conventional epoxy adhesives that do not exhibit the same degree of wash-off problems nonetheless have expansion problems.

Therefore, there exists a need for new and improved epoxy adhesive formulations, and methods of using the same, that exhibit improved wash-off resistance, T peel strength, impact strength characteristics, and expansion characteristics.

### SUMMARY OF THE INVENTION

In accordance with the general teachings of the present invention, new and improved one-part epoxy adhesive formulations having improved wash-off resistance, T peel strength, impact strength, and expansion characteristics, are provided.

In accordance with a first embodiment of the present invention, a one-part epoxy adhesive formulation is provided, comprising: (1) a fiber pulp, wherein the fiber pulp is comprised of an amine-based material; and (2) an impact modifier, wherein the impact modifier is comprised of a material selected from the group consisting of methacrylate butadiene styrene copolymer, carboxyl terminated butadiene/acrylonitrile copolymer, and combinations thereof.

In accordance with a first alternative embodiment of the present invention, a one-part epoxy adhesive formulation is provided, comprising: (1) a fiber pulp, wherein the fiber pulp is comprised of an aramid-based material; and (2) an impact modifier, wherein the impact modifier is comprised of a material selected from the group consisting of methacrylate butadiene styrene copolymer, carboxyl terminated butadiene/acrylonitrile copolymer, and combinations thereof.

In accordance with a second alternative embodiment of the present invention, a one-part epoxy adhesive formulation is provided, comprising: (1) a fiber pulp, wherein the fiber pulp is comprised of an aramid-based material, wherein the fiber pulp is present in an amount in the range of about 0.4 to about 2 weight percent based on the total weight of the one-part epoxy adhesive formulation; and (2) an impact modifier, wherein the impact modifier is comprised of a material selected from the group consisting of methacrylate butadiene styrene copolymer, carboxyl terminated butadiene/acrylonitrile copolymer, and combinations thereof, wherein the impact modifier is present in an amount in the range of about 5 to about 16 weight percent based on the total weight of the one-part epoxy adhesive formulation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a graphical view of the shear stress characteristics of a first batch (P-1) of a one-part epoxy adhesive composition of the present invention, in accordance with a first embodiment of the present invention;

FIG. 2 is a graphical view of the viscosity characteristics of a first batch (P-1) of a one-part epoxy adhesive composition of the present invention, in accordance with a second embodiment of the present invention;

FIG. 3 is a graphical view of the shear stress characteristics of a second batch (P-2) of a one-part epoxy adhesive composition of the present invention, in accordance with a third embodiment of the present invention;

FIG. 4 is a graphical view of the viscosity characteristics of a second batch (P-2) of a one-part epoxy adhesive composition of the present invention, in accordance with a fourth embodiment of the present invention;

FIG. 5 is a graphical view of the shear stress characteristics of a third batch (P-3) of a one-part epoxy adhesive composition of the present invention, in accordance with a fifth embodiment of the present invention;

FIG. 6 is a graphical view of the viscosity characteristics of a third batch (P-3) of a one-part epoxy adhesive composition of the present invention, in accordance with a sixth embodiment of the present invention;

FIG. 7 is a graphical view of the shear stress characteristics of a fourth batch (P-4) of a one-part epoxy adhesive composition of the present invention, in accordance with a seventh embodiment of the present invention;

FIG. 8 is a graphical view of the viscosity characteristics of a fourth batch (P-4) of a one-part epoxy adhesive composition of the present invention, in accordance with an eighth embodiment of the present invention;

FIG. 9 is a graphical view of the shear stress characteristics of a fifth batch (P-5) of a one-part epoxy adhesive composition of the present invention, in accordance with a ninth embodiment of the present invention;

FIG. 10 is a graphical view of the viscosity characteristics of a fifth batch (P-5) of a one-part epoxy adhesive composition of the present invention, in accordance with a tenth embodiment of the present invention;

FIG. 11 is a graphical view of the shear stress characteristics of a sixth batch (P-6) of a one-part epoxy adhesive composition of the present invention, in accordance with an eleventh embodiment of the present invention;

FIG. 12 is a graphical view of the viscosity characteristics of a sixth batch (P-6) of a one-part epoxy adhesive composition of the present invention, in accordance with a twelfth embodiment of the present invention;

FIG. 13 is a graphical view of the shear stress characteristics of a seventh batch (P-7) of a one-part epoxy adhesive composition of the present invention, in accordance with a thirteenth embodiment of the present invention;

FIG. 14 is a graphical view of the viscosity characteristics of a seventh batch (P-7) of a one-part epoxy adhesive composition of the present invention, in accordance with a fourteenth embodiment of the present invention;

FIG. 15 is a graphical view of the shear stress characteristics of an eighth batch (P-8) of a one-part epoxy adhesive composition of the present invention, in accordance with a fifteenth embodiment of the present invention;

FIG. 16 is a graphical view of the viscosity characteristics of an eighth batch (P-8) of a one-part epoxy adhesive composition of the present invention, in accordance with a sixteenth embodiment of the present invention;

FIG. 17 is a graphical view of the shear stress characteristics of a ninth batch (P-9) of a one-part epoxy adhesive composition of the present invention, in accordance with a seventeenth embodiment of the present invention;

FIG. 18 is a graphical view of the viscosity characteristics of a ninth batch (P-9) of a one-part epoxy adhesive composition of the present invention, in accordance with an eighteenth embodiment of the present invention;

FIG. 19 is a graphical view of the shear stress characteristics of a tenth batch (P-10) of a one-part epoxy adhesive composition of the present invention, in accordance with a nineteenth embodiment of the present invention;

FIG. 20 is a graphical view of the viscosity characteristics of a tenth batch (P-10) of a one-part epoxy adhesive composition of the present invention, in accordance with a twentieth embodiment of the present invention;

FIG. 21 is a graphical view of the shear stress characteristics of an eleventh batch (P-11) of a one-part epoxy adhesive composition of the present invention, in accordance with a twenty-first embodiment of the present invention;

FIG. 22 is a graphical view of the viscosity characteristics of an eleventh batch (P-11) of a one-part epoxy adhesive composition of the present invention, in accordance with a twenty-second embodiment of the present invention;

FIG. 23 is a graphical view of the shear stress characteristics of a twelfth batch (338) of a one-part epoxy adhesive composition of the present invention, in accordance with a twenty-third embodiment of the present invention; and

FIG. 24 is a graphical view of the viscosity characteristics of a twelfth batch (338) of a one-part epoxy adhesive composition of the present invention, in accordance with a twenty-fourth embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention is primarily directed to reactive one-part epoxy adhesive formulations, and methods for using the same. The one-part epoxy adhesive formulations of the present invention are particularly suitable for bonding metallic articles to other metallic articles, metallic articles to non-metallic articles, and non-metallic articles to non-metallic articles. By way of a non-limiting example, the one-part epoxy adhesive formulations of the present invention are particularly suitable for forming automotive exterior panel systems, including metallic and/or non-metallic panel members. By way of another non-limiting example, the one-part epoxy adhesive formulations of the present invention can be employed to bond stamped metal parts together, SMC parts to steel parts, as well as SMC parts to other SMC parts, especially for automotive assembly purposes. By way of still another non-limiting example, the one-part epoxy adhesive formulations of the present invention can be employed to bond thermoset and thermoplastic (e.g., high-energy thermoplastic) parts to various substrates, especially for automotive assembly purposes.

In accordance with one embodiment of the present invention, at least one liquid epoxy resin is provided. The liquid epoxy resin is preferably a liquid reaction product of epichlorohydrin and bisphenol, e.g., a diglycidyl ether of bisphenol-A (“DGEBA”). In accordance with a highly preferred embodiment of the present invention, the liquid epoxy resin is comprised of D.E.R. 331, a liquid reaction product of epichlorohydrin and bisphenol A, which is readily commercially available from the Dow Chemical Company (Midland, Mich.). The DGEBA is preferably the base resin of the epoxy adhesive of the present invention.

Typical properties of D.E.R. 331 are set forth in Table I, below:

TABLE I

| Property | Description | Testing Method |
|---|---|---|
| Epoxide Equivalent Weight, | 182-192 | ASTM D-1652 |
| (g/eq) | | |
| Percentage epoxide (%) | 22.4-23.6 | ASTM D-1652 |
| Epoxide Group Content | 5200-5500 | ASTM D-1652 |
| (mmol/kg) | | |
| Viscosity @ 25° C. (77° F.), (cps) | 11000-14000 | ASTM D-445 |
| Density @ 25° C. (g/ml) | 1.16 | ASTM D-1475 |
| Color, Platinum Cobalt | 75 | ASTM D-1209 |
| Hydrolyzable Chloride Content, | 500 | RPM 105-D |
| (max. ppm) | | |
| Epichlorohydrin Content (max. | 5 | RPM 900-A |
| ppm) | | |
| Non-volatile Content, (wt. %) | 100 | RPM 104-B |
| Flash Point, (° C.) | 252 | ASTM D-93 |
| Water content (max. ppm) | 700 | ASTM E-203 |

In accordance with a preferred embodiment of the present invention, the liquid epoxy resin is present in the range of about 50 to about 70 weight percent, based on the total weight of the epoxy one-part adhesive formulation. In accordance with a more preferred embodiment of the present invention, the liquid epoxy resin is present in the range of about 55 to about 65 weight percent, based on the total weight of the epoxy one-part adhesive formulation. In accordance with a highly preferred embodiment of the present invention, the liquid epoxy resin is present in the range of about 58 to about 62 weight percent, based on the total weight of the epoxy one-part adhesive formulation.

In accordance with one embodiment of the present invention, at least one other liquid epoxy resin is provided. In accordance with a preferred embodiment of the present invention, the at least one other liquid epoxy resin is a reaction product of epichlorohydrin and polypropylene glycol, e.g., a polyglycol diepoxide. In accordance with a highly preferred embodiment of the present invention, the at least one other liquid epoxy resin is comprised of D.E.R. 732, a reaction product of epichlorohydrin and polypropylene glycol, which is readily commercially available from the Dow Chemical Company (Midland, Mich.). The polyglycol diepoxide preferably aids in viscosity control and reduction of brittleness of the epoxy adhesive of the present invention.

Typical properties of D.E.R. 732 are set forth in Table II, below:

TABLE II

| Property | Description | Testing Method |
|---|---|---|
| Epoxide Equivalent Weight, | 310-330 | ASTM D-1652 |
| (g/eq) | | |
| Viscosity @ 25° C. (77° F.), | 55-75 | ASTM D-445 |
| (mPa.s) | | |
| Density @ 25° C. (77° F.), (g/ml) | 1.06 | ASTM D-4052 |
| Color, Platinum Cobalt | 60 Max. | ASTM D-1209 |
| Hydrolyzable Chloride Content, | 2000 Max. | RPM 105-D |
| (ppm) | | |
| Non-volatile Content, (wt. %) | 99.5 Min. | RPM 104-A |
| Flash Point, (° C.) | 194 | ASTM D-3278 |

In accordance with a preferred embodiment of the present invention, the reaction product of epichlorohydrin and polypropylene glycol is present in the range of about 2 to about 10 weight percent, based on the total weight of the epoxy resin component formulation. In accordance with a more preferred embodiment of the present invention, the reaction product of epichlorohydrin and polypropylene glycol is present in the range of about 3 to about 9 weight percent, based on the total weight of the epoxy resin component formulation. In accordance with a highly preferred embodiment of the present invention, the reaction product of epichlorohydrin and polypropylene glycol is present in the range of about 5 to about 7 weight percent, based on the total weight of the epoxy resin component formulation.

In accordance with one embodiment of the present invention, at least one impact modifier is provided. The impact modifier is preferably comprised of methacrylate butadiene styrene. In accordance with a highly preferred embodiment of the present invention, the impact modifier is comprised of PARALOID EXL-2691A, a powdered methacrylate butadiene styrene (“p(BD/MMA/STY”) impact modifier that is readily commercially available from Rohm and Haas (Philadelphia, Pa.). Alternatively, the impact modifier can be comprised of a carboxyl terminated butadiene/acrylonitrile (“CTBN”) copolymer. The p(BD/MMA/STY) preferably improves impact strength and wash-off resistance of the epoxy adhesive of the present invention.

In accordance with a preferred embodiment of the present invention, the impact modifier is present in the range of about 5 to about 16 weight percent, based on the total weight of the epoxy one-part adhesive formulation. In accordance with a more preferred embodiment of the present invention, the impact modifier is present in the range of about 9 to about 15 weight percent, based on the total weight of the epoxy one-part adhesive formulation. In accordance with a highly preferred embodiment of the present invention, the impact modifier is present in the range of about 11 to about 13 weight percent, based on the total weight of the epoxy one-part adhesive formulation.

In accordance with one embodiment of the present invention, at least one fiber pulp, and still more preferably, an amine-based pulp, and most preferably, an aramid-based pulp is provided. In accordance with a highly preferred embodiment of the present invention, the fiber pulp is comprised of poly(terephthaloylchloride/p-phenylenediamine) and is readily commercially available from Teijin Limited (Tokyo, Japan) under the trade name TWARON D 2091 or from DuPont Corp. (Wilmington, Del.) under the trade name KEVLAR aramid pulp. The aramid pulp preferably improves impact strength, wash-off resistance, and rheology of the epoxy adhesive of the present invention.

The aramid pulp preferably includes a fiber length in the range of about 0.85 to about 1.35 mm (e.g., 1.10 mm median), an aspect ratio in the range of about 65 to about 100, and a specific surface area in the range of about 12 to about 15 m²/g.

In accordance with a preferred embodiment of the present invention, the aramid pulp is present in the range of about 0.4 to about 2 weight percent, based on the total weight of the epoxy resin component formulation. In accordance with a more preferred embodiment of the present invention, the aramid pulp is present in the range of about 0.8 to about 1.6 weight percent, based on the total weight of the epoxy resin component formulation. In accordance with a highly preferred embodiment of the present invention, the aramid pulp is present in the range of about 1 to about 1.4 weight percent, based on the total weight of the epoxy resin component formulation.

In accordance with one embodiment of the present invention, at least one coupling agent, and still more preferably, a silane-based coupling agent, and most preferably, a silane-based coupling agent containing an epoxy group., is provided In accordance with a highly preferred embodiment of the present invention, the coupling agent is comprised of gamma-glycidochloropropyl methyl trimethoxy silane and is readily commercially available from Crompton Corp. (Middlebury, Conn.) under the trade name SILANE A-187. The silane-based coupling agent preferably promotes adhesion of the epoxy adhesive of the present invention.

In accordance with a preferred embodiment of the present invention, the coupling agent is present in the range of about 0.1 to about 1 weight percent, based on the total weight of the epoxy resin component formulation. In accordance with a more preferred embodiment of the present invention, the coupling agent is present in the range of about 0.2 to about 0.5 weight percent, based on the total weight of the epoxy resin component formulation. In accordance with a highly preferred embodiment of the present invention, the coupling agent is present in the range of about 0.2 to about 0.3 weight percent, based on the total weight of the epoxy resin component formulation.

In accordance with one embodiment of the present invention, at least one latent curing agent is provided. In accordance with a preferred embodiment of the present invention, the latent curing agent is comprised of dicyandiamide. In accordance with a more preferred embodiment of the present invention, the latent curing agent is comprised of a micronized grade of dicyandiamide. In accordance with a highly preferred embodiment of the present invention, the latent curing agent is comprised of AMICURE CG-1200, a micronized grade of dicyandiamide that is readily commercially available from Air Products (Allentown, Pa.). The dicyandiamide is preferably pulverized to 90% less than 30 micron size particles.

Typical properties of AMICURE CG-1200 are set forth in Table III, below:

TABLE III

| Property | Value |
|---|---|
| Appearance | White, Crystalline Particles |
| Melt Point (° F.) | 405-406 |
| Particle Size (microns) 90% | <30 |
| Particle Size (microns) 90% | <11 |
| Nitrogen as % of DICY | 99 |
| Equivalent Wt/{H} | 21 |
| Recommended Use Level (phr, | 4-15 |
| EEW = 190) | |
| Gel Time (150 g mass @ 77° F.) (mo) | 12 |
| Tg (° F.) | 250 |

In accordance with a preferred embodiment of the present invention, the latent curing agent is present in the range of about 3 to about 15 weight percent, based on the total weight of the epoxy one-part adhesive formulation. In accordance with a more preferred embodiment of the present invention, the latent curing agent is present in the range of about 4 to about 10 weight percent, based on the total weight of the epoxy one-part adhesive formulation. In accordance with a highly preferred embodiment of the present invention, the latent curing agent is present in the range of about 5 to about 8 weight percent, based on the total weight of the epoxy one-part adhesive formulation.

In accordance with one embodiment of the present invention, at least one pigment, and still more preferably, a black pigment, and most preferably, carbon black, is provided. In accordance with a highly preferred embodiment of the present invention, the carbon black is comprised of CSX 652A and is readily commercially available from Cabot Corp. (Billerica, Mass.). The carbon black is preferably useful as a colorant for imparting a color effect to the epoxy adhesive of the present invention.

In accordance with a preferred embodiment of the present invention, the carbon black is present in the range of about 0.5 to about 4 weight percent, based on the total weight of the epoxy resin component formulation. In accordance with a more preferred embodiment of the present invention, the carbon black is present in the range of about 0.5 to about 2 weight percent, based on the total weight of the epoxy resin component formulation. In accordance with a highly preferred embodiment of the present invention, the carbon black is present in the range of about 0.7 to about 1 weight percent, based on the total weight of the epoxy resin component formulation.

In accordance with one embodiment of the present invention, at least one accelerator is provided. In accordance with a preferred embodiment of the present invention, the accelerator is comprised of an aromatic substituted urea. In accordance with a more preferred embodiment of the present invention, the accelerator is comprised of phenyl dimethyl urea. In accordance with a highly preferred embodiment of the present invention, the accelerator is comprised of OMICURE U405, a phenyl dimethyl urea accelerator that is readily commercially available from CVC Specialty Chemicals (Maple Shade, N.J.). The phenyl dimethyl urea is preferably useful as a low temperature latent curing agent for the epoxy adhesive of the present invention.

Typical properties of OMICURE U-405 are set forth in Table IV, below:

TABLE IV

| Property | Value |
|---|---|
| Appearance | Clean Powder |
| Color | Off White |
| Odor | Ammoniacal |
| Melting Point (° C.) | 126-136 |
| Moisture Content, max. % | 0.7 |
| Particle size, min. % through a 325 mesh | 80 |
| screen | |

In accordance with a preferred embodiment of the present invention, the accelerator is present in the range of about 0.2 to about 4 weight percent, based on the total weight of the epoxy one-part adhesive formulation. In accordance with a more preferred embodiment of the present invention, the accelerator is present in the range of about 0.2 to about 2 weight percent, based on the total weight of the epoxy one-part adhesive formulation. In accordance with a highly preferred embodiment of the present invention, the accelerator is present in the range of about 0.2 to about 1 weight percent, based on the total weight of the epoxy one-part adhesive formulation.

In accordance with one embodiment of the present invention, at least one other latent curing agent is provided. In accordance with a preferred embodiment of the present invention, the at least one other latent curing agent is comprised of a modified polyamine. In accordance with a more preferred embodiment of the present invention, the at least one other latent curing agent is comprised of a micronized grade of dicyandiamide. In accordance with a highly preferred embodiment of the present invention, the at least one other latent curing agent is comprised of ANCAMINE 2014AS, a micronized grade of dicyandiamide that is readily commercially available from Air Products (Allentown, Pa.). The dicyandiamide is preferably useful as a low temperature latent curing agent for the epoxy adhesive of the present invention.

Typical properties of ANCAMINE 2014AS are set forth in Table V, below:

TABLE V

| Property | Value |
|---|---|
| Appearance | White micronized powder |
| Amine Value (mg KOH/g) | 184 |
| Equivalent Wt/{H} | 52 |
| Use Level (phr) | 25 |
| Melt Point (° F.) | 208-223 |

In accordance with a preferred embodiment of the present invention, the at least one other latent curing agent is present in the range of about 0.5 to about 4 weight percent, based on the total weight of the epoxy one-part adhesive formulation. In accordance with a more preferred embodiment of the present invention, the at least one other latent curing agent is present in the range of about 0.5 to about 2 weight percent, based on the total weight of the epoxy one-part adhesive formulation. In accordance with a highly preferred embodiment of the present invention, the at least one other latent curing agent is present in the range of about 0.5 to about 1 weight percent, based on the total weight of the epoxy one-part adhesive formulation.

In accordance with one embodiment of the present invention, at least one blowing agent is provided. In accordance with a preferred embodiment of the present invention, the blowing agent is comprised of a low-temperature blowing agent. In accordance with a more preferred embodiment of the present invention, the latent curing agent is comprised of an azodicarbonamide. In accordance with a highly preferred embodiment of the present invention, the blowing agent is comprised of CELOGEN AZ3990, a blowing agent that is readily commercially available from Crompton Corp. (Middlebury, Conn.). The azodicarbonamide is preferably useful as a low temperature blowing agent for the epoxy adhesive of the present invention.

Typical properties of CELOGEN AZ3990 are set forth in Table VI, below:

TABLE VI

| Property | Value |
|---|---|
| Appearance | Fine Yellow Powder |
| Gas/Gram | 220 cc's @ STP |
| Gas Composition | 65% N, 24% CO, 5% CO₂, 5% NH₃ |
| Decomposition Range | 401-419° F. (205-215° C.) |
| Specific Gravity | 1.65 @ 25° C. |
| Average Particle Size (microns) | 4.0-5.0 |

In accordance with a preferred embodiment of the present invention, the blowing agent is present in the range of about 0.2 to about 2 weight percent, based on the total weight of the epoxy one-part adhesive formulation. In accordance with a more preferred embodiment of the present invention, the blowing agent is present in the range of about 0.2 to about 1.5 weight percent, based on the total weight of the epoxy one-part adhesive formulation. In accordance with a highly preferred embodiment of the present invention, the blowing agent is present in the range of about 0.2 to about 1 weight percent, based on the total weight of the epoxy one-part adhesive formulation.

In accordance with one embodiment of the present invention, at least one stabilizer is provided. The stabilizer preferably includes a wollastonite-based stabilizer. In accordance with a highly preferred embodiment of the present invention, the stabilizer is comprised of NYAD 400 and is readily commercially available from NYCO Minerals, Inc. (Willsboro, N.Y.). The wollastonite-based stabilizer is preferably useful to improve fiber dispersion, durability, and prevent micro cracking of the epoxy adhesive of the present invention.

Typical properties of NYAD 400 are set forth in Table VII, below:

TABLE VII

| Property | Value |
|---|---|
| Particle Length (μm) | 35 |
| Particle Diameter (μm) | 7 |
| Aspect Ratio | 5 |

In accordance with a preferred embodiment of the present invention, the stabilizer is present in the range of about 5 to about 20 weight percent, based on the total weight of the epoxy one-part adhesive formulation. In accordance with a more preferred embodiment of the present invention, the stabilizer is present in the range of about 9 to about 20 weight percent, based on the total weight of the epoxy one-part adhesive formulation. In accordance with a highly preferred embodiment of the present invention, the stabilizer is present in the range of about 9 to about 15 weight percent, based on the total weight of the epoxy one-part adhesive formulation.

In accordance with one embodiment of the present invention, at least one thickener is provided. The thickener preferably includes a silica-based thickener, and more preferably, a fumed silica thickener. In accordance with a highly preferred embodiment of the present invention, the fumed silica thickener is comprised of CAB-O-SIL TS-720 and is readily commercially available from Cabot Corp. (Billerica, Mass.). The fumed silica thickener is preferably useful as viscosity and rheology control for the epoxy adhesive of the present invention.

In accordance with a preferred embodiment of the present invention, the thickener is present in the range of about 1 to about 5 weight percent, based on the total weight of the epoxy one-part adhesive formulation. In accordance with a more preferred embodiment of the present invention, the thickener is present in the range of about 2 to about 4 weight percent, based on the total weight of the epoxy one-part adhesive formulation. In accordance with a highly preferred embodiment of the present invention, the thickener is present in the range of about 2 to about 3 weight percent, based on the total weight of the epoxy one-part adhesive formulation.

In accordance with a non-limiting example, the one-part epoxy adhesive formulation of the present invention may be manufactured in any number of suitable manners. For example, the following procedure can be employed to blend the respective ingredients of the one-part epoxy adhesive formulation of the present invention. Equipment used in this process included a mixer (e.g., such as a ROSS, MYERS, or similar type), a vacuum pump, a pneumatic pump, and a weight scale. First, a portion of the D.E.R. 331 epoxy resin was combined with the TWARON D 2091 aramid pulp to form a first mixture. The PARALOID EXL-2691 p(BD/MMA/STY, D.E.R. 732 epoxy resin and another portion of the D.E.R. 331 epoxy resin were combined to form a second mixture. Then, the remainder of the D.E.R. 331 epoxy resin and SILANE A187 coupling agent were combined together with the first and second mixtures to form a third mixture. Then, the AMICURE CG 1200 latent curing agent and NYAD 400 wollastonite were added to the third mixture to form a fourth mixture. Finally, the CSX 652 carbon black, OMICURE U-405 accelerator, ANCAMINE 2014AS latent curing agent, CELOGEN AZ3990 blowing agent, and TS 720 fumed silica were combined with the fourth mixture to form the final mixture of the present invention.

The one-part adhesive formulation of the present invention can be applied to various substrates including metallic (e.g., steel, aluminum, magnesium and so forth) and non-metallic (e.g., thermoplastics and thermosets) in order to bond the various substrates to one another. By way of a non-limiting example, the one-part adhesive formulation can be used to bond metallic substrates such as, but not limited to hot dipped galvanized steel, electro-galvanized steel, cold rolled steel, aluminum and magnesium. By way of a non-limiting example, the one-part adhesive formulation can be used to bond non-metallic substrates such as, but not limited to SMC and high surface energy thermoplastics.

One application of the one-part adhesive formulation of the present invention can include, without limitation, the bonding of SMC parts such as automotive doors, hoods, tailgates and other body panels. The bonding process can be carried out at a manufacturing facility (e.g., stamping plant), assembly facility (automotive plant), or repair facility (e.g., body shop).

Once the individual components of the one-part adhesive formulation are combined in accordance with the previously described ratios, the one-part adhesive formulation of the present invention is preferably be applied to at least one of the respective surface(s) to be joined together. By way of non-limiting examples, the one-part adhesive formulation can be: (1) applied to one surface of an article or component to be bonded to another article or component; and/or (2) applied to one or more surfaces of adjacent or abutting surfaces of two or more articles or components to be bonded together.

The one-part adhesive formulation of the present invention is preferably capable of being applied to a surface either manually or automatically, and can preferably be applied with a pump, sprayer, roller, dipper, and any other suitable methods. By way of a non-limiting example, the one-part adhesive formulation of the present invention can be streamed, swirled, extruded, roll coated, flow coated, flow brushed or spray applied onto a surface.

In order to determine the effectiveness of the one-part adhesive formulation of the present invention several comparative tests were conducted to evaluate the performance of the one-part adhesive formulation of the present invention.

In the first series of tests, the yield stress and press flow viscosity characteristics of the one-part adhesive formulations of the present invention was evaluated against one another to determine optimal formulations therefor, especially with respect to the weight percentages of the aramid fiber and p(BD/MMA/STY) components. The testing was conducted on a RHEOMETRICS AR-2000 dynamic stress rheometer. The test method was conducted in accordance with GEX-Method #350 Sprachcode E—“Rheology Determination of Epoxy Adhesives”—Physical A program. Testing was conducted at 25° C., a gap of 28 microns, and a geometry of a 1° 25 mm steel cone. The press flow test method was conducted in general accordance with SAE J243 ADS-1. The results of the testing are presented in Table VIII, below:

TABLE VIII

| | | | | Press Flow |
|---|---|---|---|---|
| | | | | Viscosity (sec./20 |
| Batch | Aramid Pulp | P(BD/MMA/STY) | Yield | grams), 40 psi, |
| No. | (Wt. %) | (Wt. %) | Stress (Pa) | 0.104 inch orifice |
| P-1 | 0 | 11.5 | 41 | 75 |
| P-2 | 0.4 | 11.5 | 69 | 87 |
| P-3 | 0.8 | 11.5 | 103 | 111 |
| P-4 | 1.6 | 11.5 | 204 | 156 |
| P-5 | 2 | 11.5 | 224 | 176 |
| P-6 | 1.2 | 7.5 | 138 | 66 |
| P-7 | 1.2 | 9.5 | 133 | 88 |
| P-8 | 1.2 | 13.5 | 157 | 160 |
| P-9 | 1.2 | 0 | 105 | 26 |
| P-10 | 1.2 | 5.5 | 139 | 48 |
| P-11 | 1.2 | 3.5 | 110 | 35 |
| 338 | 1.2 | 11.5 | 160 | 119 |

As the results in Table VIII illustrate, the one-part adhesive formulations of the present invention exhibit superior yield stress and press flow viscosity characteristics, especially those formulations that include both aramid pulp and p(BD/MMA/STY).

In a second series of tests, the expansion characteristics of the one-part adhesive formulations of the present invention were evaluated against one another to determine optimal formulations therefor, especially with respect to the weight percentages of the aramid fiber and p(BD/MMA/STY) components, in general accordance with testing procedure FLTM BV 108-02, with the exception of the following conditions: 30 min. @325° F., 5 mm radius, as opposed to 8 min. @275° F., 8 mm radius. The results of the testing are presented in Table IX, below:

TABLE IX

| | | p(BD/MMA/STY) | Expansion |
|---|---|---|---|
| Batch No. | Aramid Pulp (Wt. %) | (Wt. %) | (10 × 5 mm) % |
| P-1 | 0 | 11.5 | 78.4 |
| P-2 | 0.4 | 11.5 | 77.6 |
| P-3 | 0.8 | 11.5 | 67.9 |
| P-4 | 1.6 | 11.5 | 61.9 |
| P-5 | 2 | 11.5 | 61.7 |
| P-6 | 1.2 | 7.5 | 64.9 |
| P-7 | 1.2 | 9.5 | 65.4 |
| P-8 | 1.2 | 13.5 | 71.5 |
| P-9 | 1.2 | 0 | 41.8 |
| P-10 | 1.2 | 5.5 | 59.6 |
| P-11 | 1.2 | 3.5 | 52.6 |
| 338 | 1.2 | 11.5 | 71.1 |

As the results in Table IX illustrate, the one-part adhesive formulations of the present invention exhibit superior expansion characteristics, especially those formulations that include both aramid pulp and p(BD/MMA/STY).

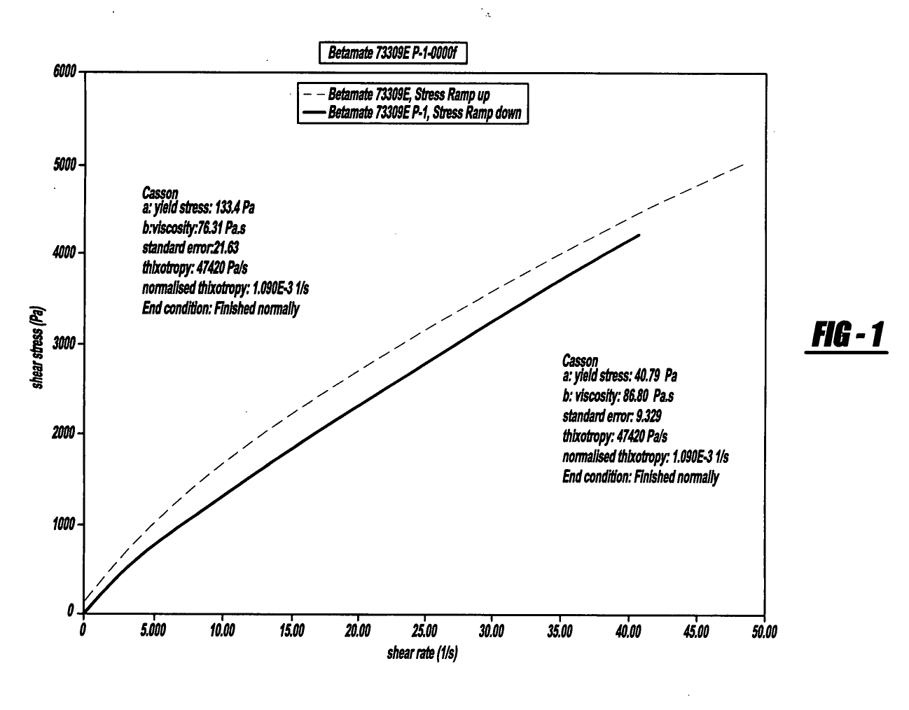

Referring to FIG. 1, there is shown a graphical view of the shear stress characteristics of a first batch (P-1) of a one-part epoxy adhesive composition of the present invention, in accordance with a first embodiment of the present invention.

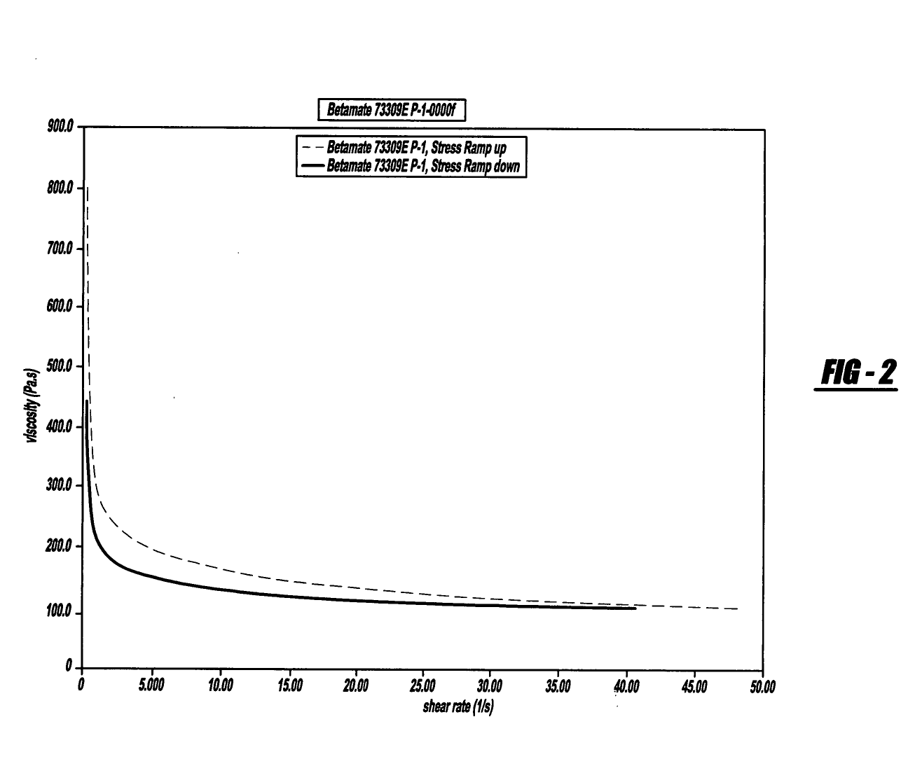

Referring to FIG. 2, there is shown a graphical view of the viscosity characteristics of a first batch (P-1) of a one-part epoxy adhesive composition of the present invention, in accordance with a second embodiment of the present invention.

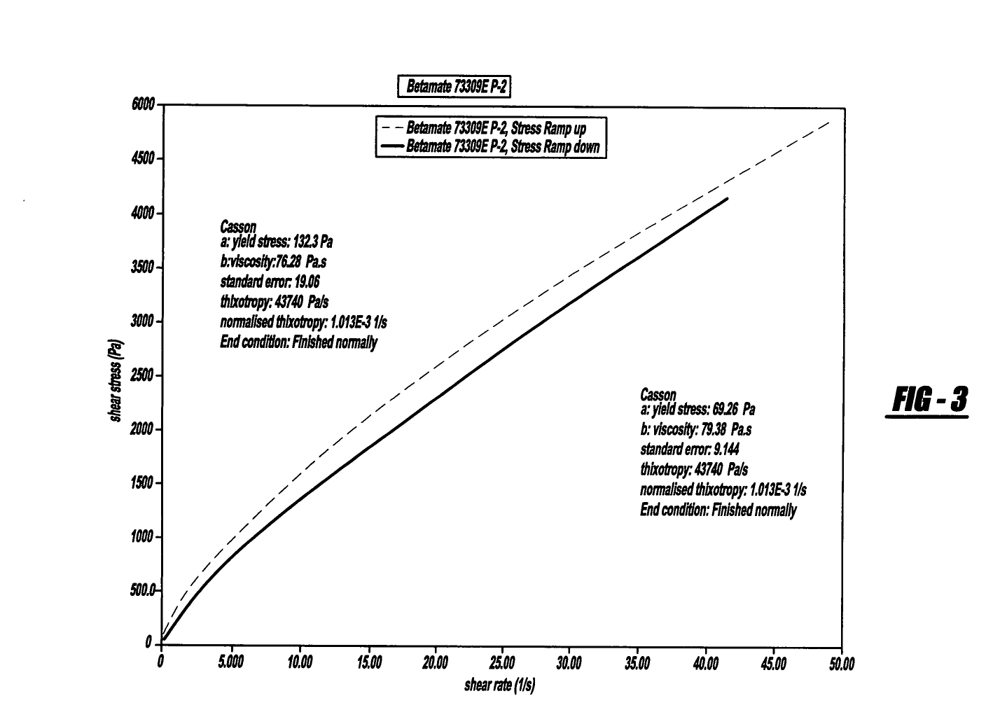

Referring to FIG. 3, there is shown a graphical view of the shear stress characteristics of a second batch (P-2) of a one-part epoxy adhesive composition of the present invention, in accordance with a third embodiment of the present invention.

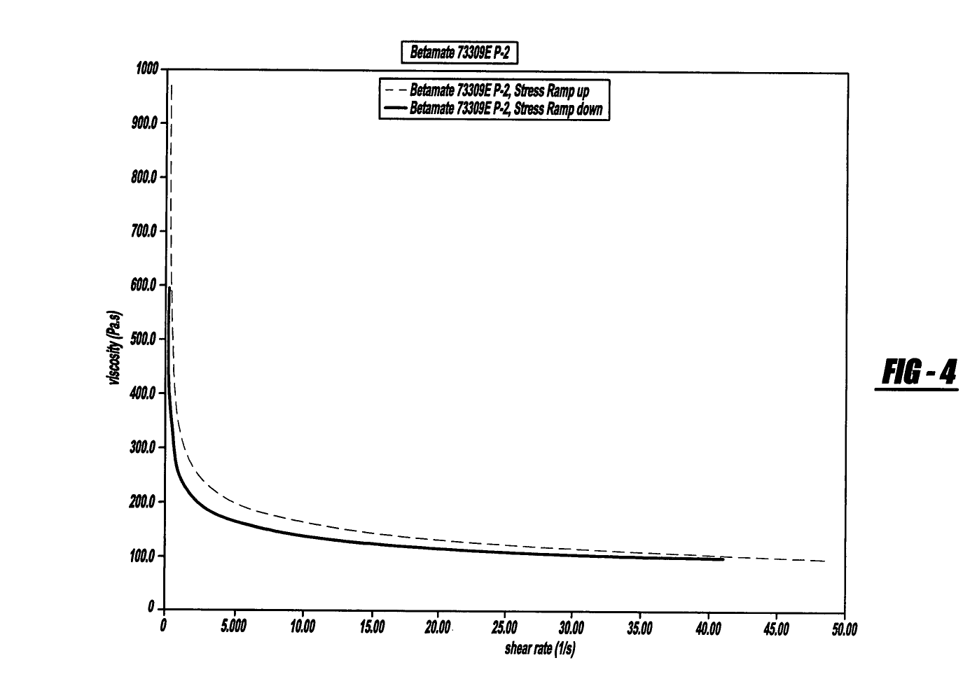

Referring to FIG. 4, there is shown a graphical view of the viscosity characteristics of a second batch (P-2) of a one-part epoxy adhesive composition of the present invention, in accordance with a fourth embodiment of the present invention.

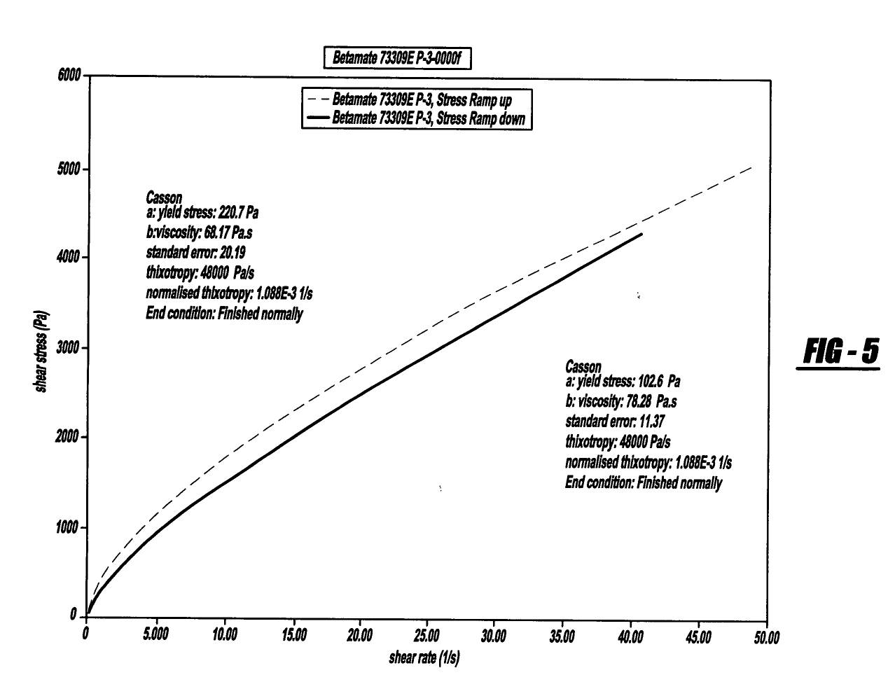

Referring to FIG. 5, there is shown a graphical view of the shear stress characteristics of a third batch (P-3) of a one-part epoxy adhesive composition of the present invention, in accordance with a fifth embodiment of the present invention.

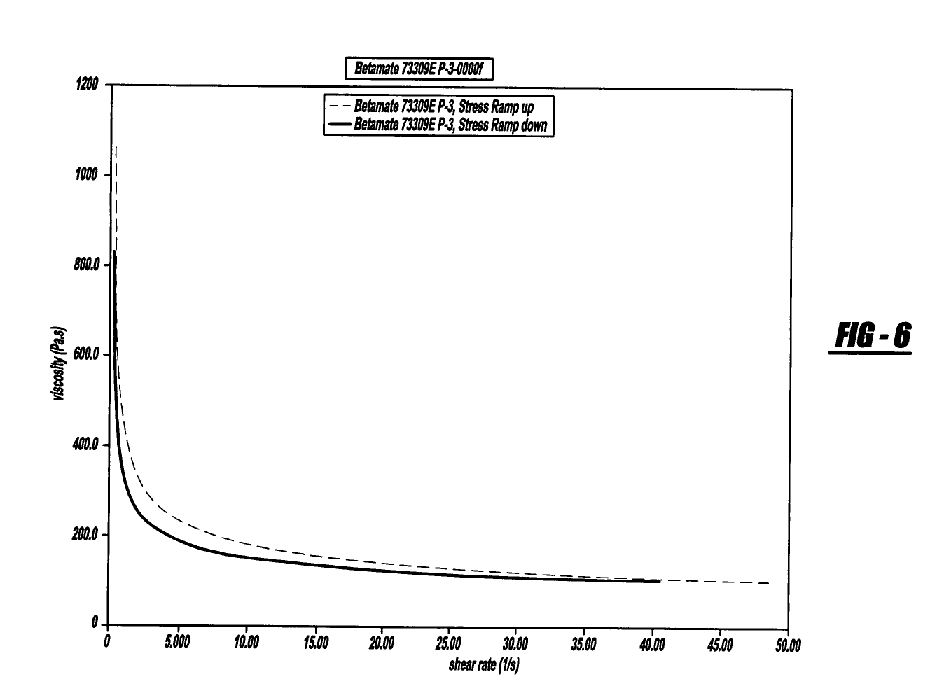

Referring to FIG. 6, there is shown a graphical view of the viscosity characteristics of a third batch (P-3) of a one-part epoxy adhesive composition of the present invention, in accordance with a sixth embodiment of the present invention.

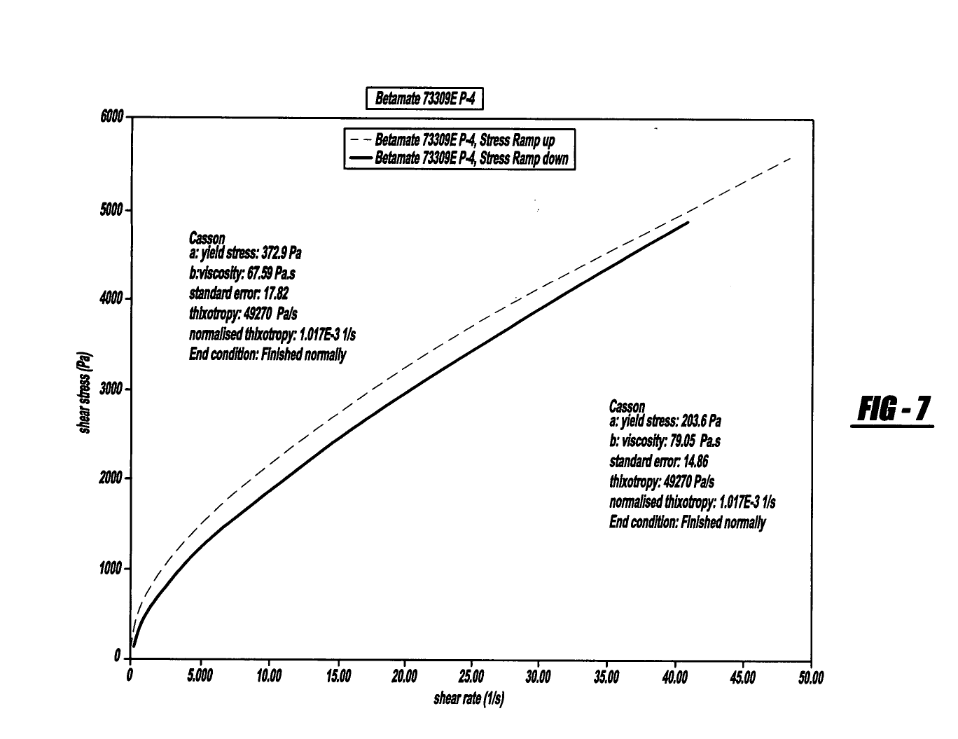

Referring to FIG. 7, there is shown a graphical view of the shear stress characteristics of a fourth batch (P-4) of a one-part epoxy adhesive composition of the present invention, in accordance with a seventh embodiment of the present invention.

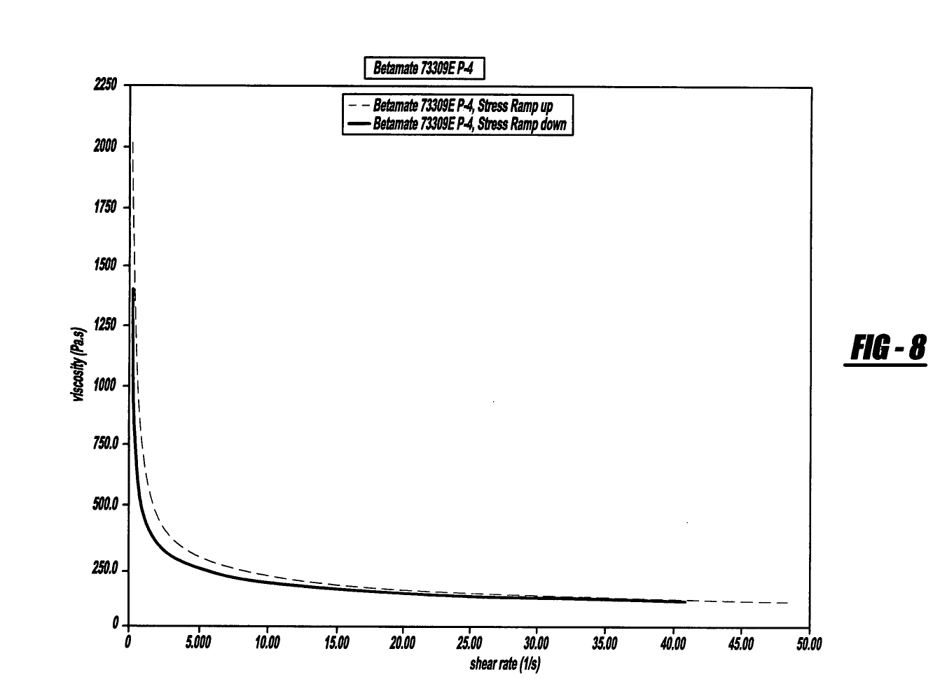

Referring to FIG. 8, there is shown a graphical view of the viscosity characteristics of a fourth batch (P-4) of a one-part epoxy adhesive composition of the present invention, in accordance with an eighth embodiment of the present invention.

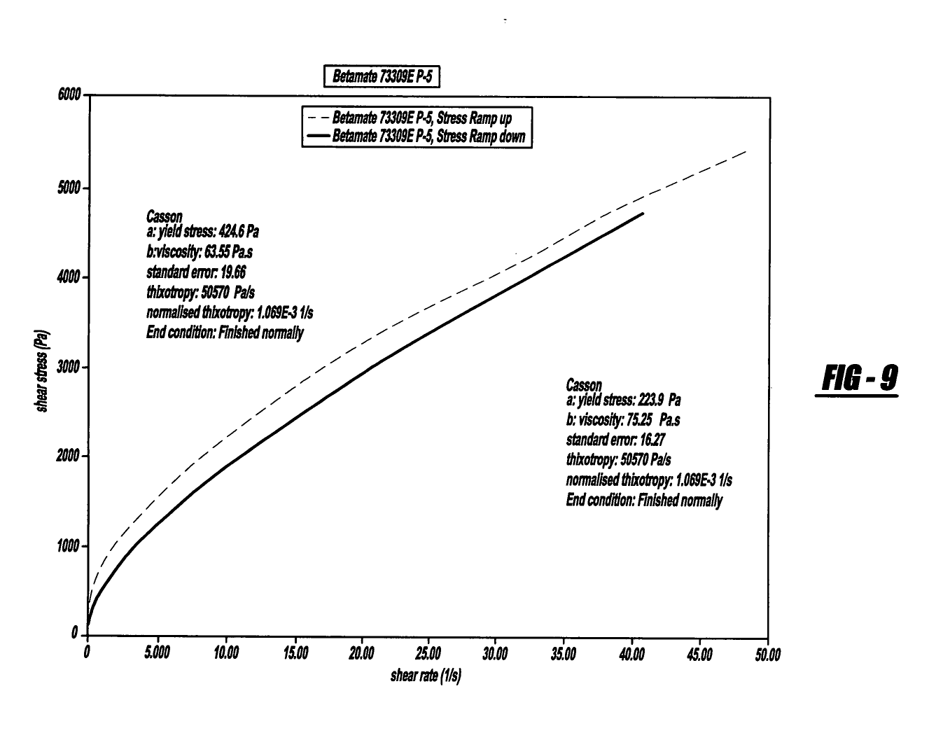

Referring to FIG. 9, there is shown a graphical view of the shear stress characteristics of a fifth batch (P-5) of a one-part epoxy adhesive composition of the present invention, in accordance with a ninth embodiment of the present invention.

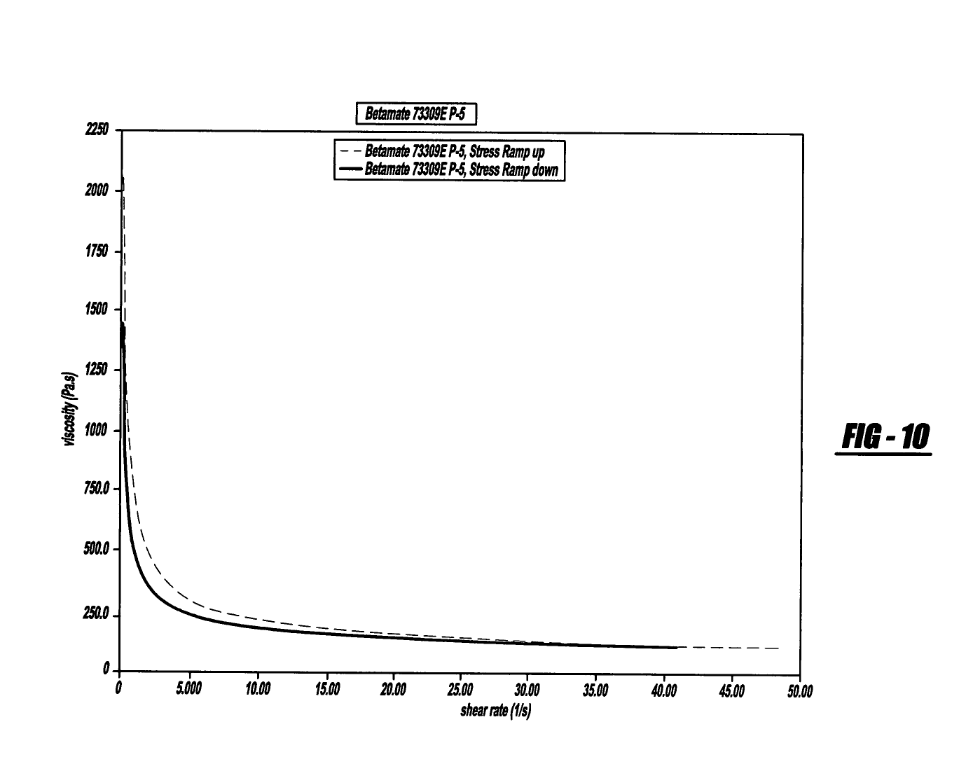

Referring to FIG. 10, there is shown a graphical view of the viscosity characteristics of a fifth batch (P-5) of a one-part epoxy adhesive composition of the present invention, in accordance with a tenth embodiment of the present invention.

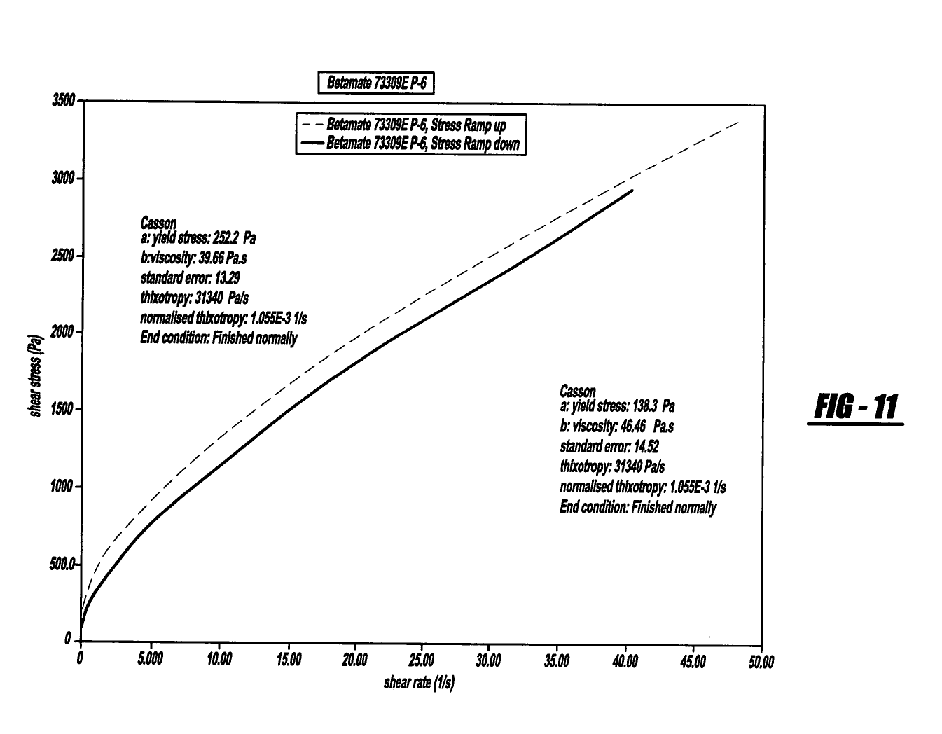

Referring to FIG. 11, there is shown a graphical view of the shear stress characteristics of a sixth batch (P-6) of a one-part epoxy adhesive composition of the present invention, in accordance with an eleventh embodiment of the present invention.

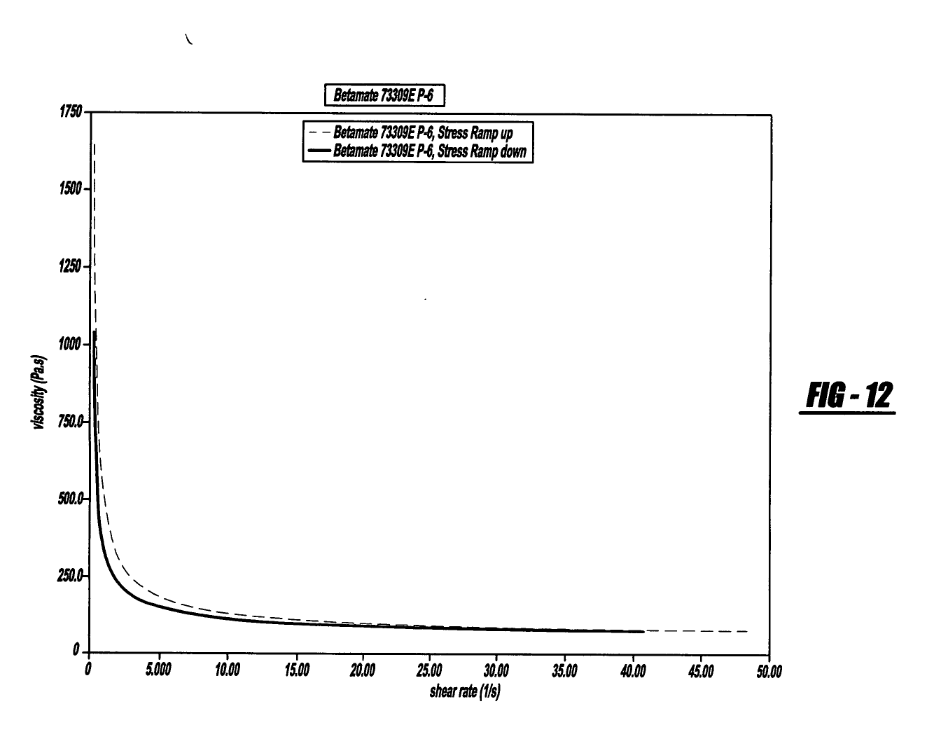

Referring to FIG. 12, there is shown a graphical view of the viscosity characteristics of a sixth batch (P-6) of a one-part epoxy adhesive composition of the present invention, in accordance with a twelfth embodiment of the present invention.

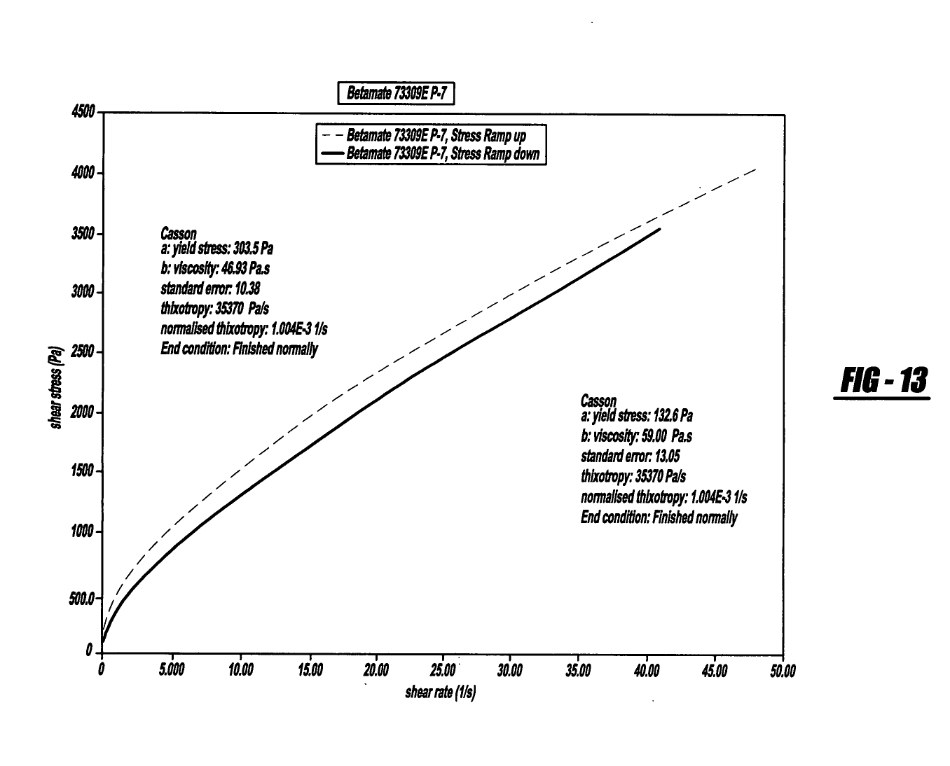

Referring to FIG. 13, there is shown a graphical view of the shear stress characteristics of a seventh batch (P-7) of a one-part epoxy adhesive composition of the present invention, in accordance with a thirteenth embodiment of the present invention.

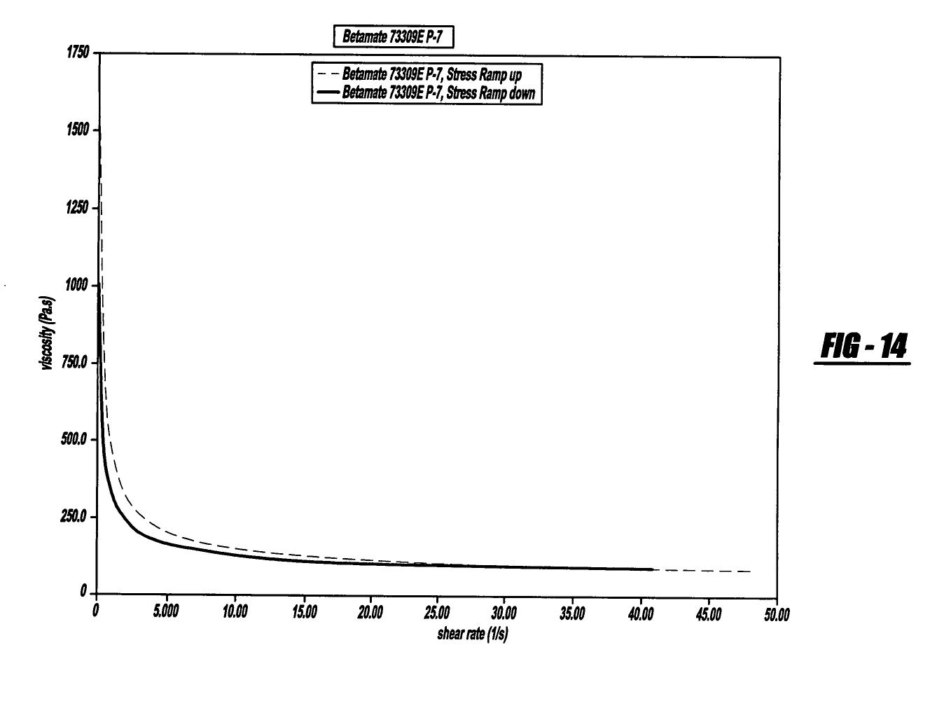

Referring to FIG. 14, there is shown a graphical view of the viscosity characteristics of a seventh batch (P-7) of a one-part epoxy adhesive composition of the present invention, in accordance with a fourteenth embodiment of the present invention.

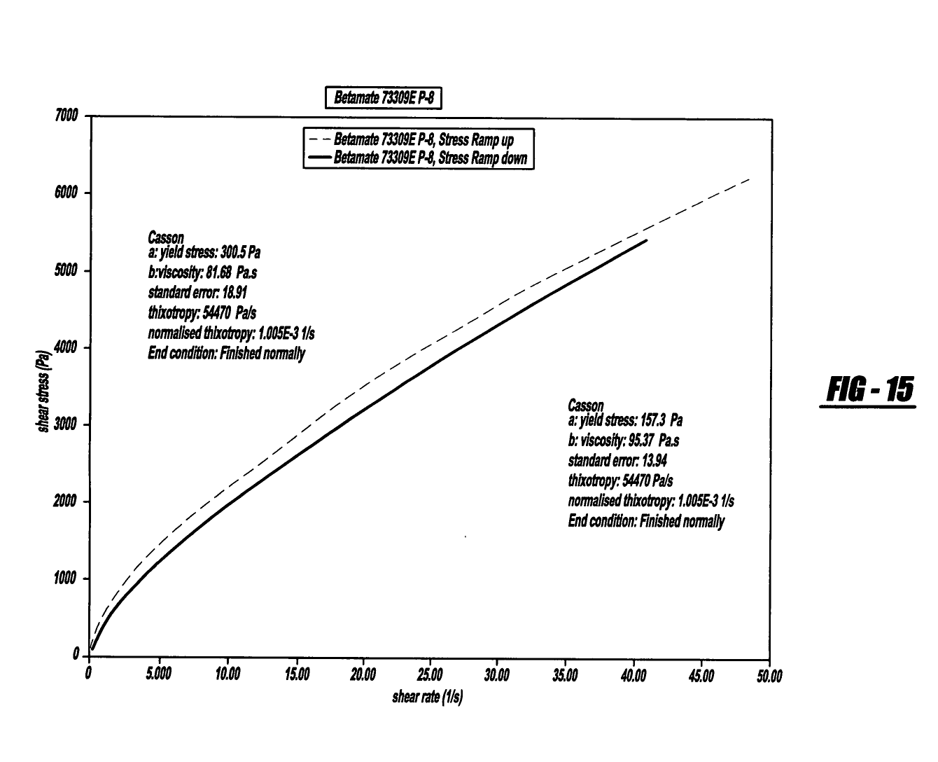

Referring to FIG. 15, there is shown a graphical view of the shear stress characteristics of an eighth batch (P-8) of a one-part epoxy adhesive composition of the present invention, in accordance with a fifteenth embodiment of the present invention.

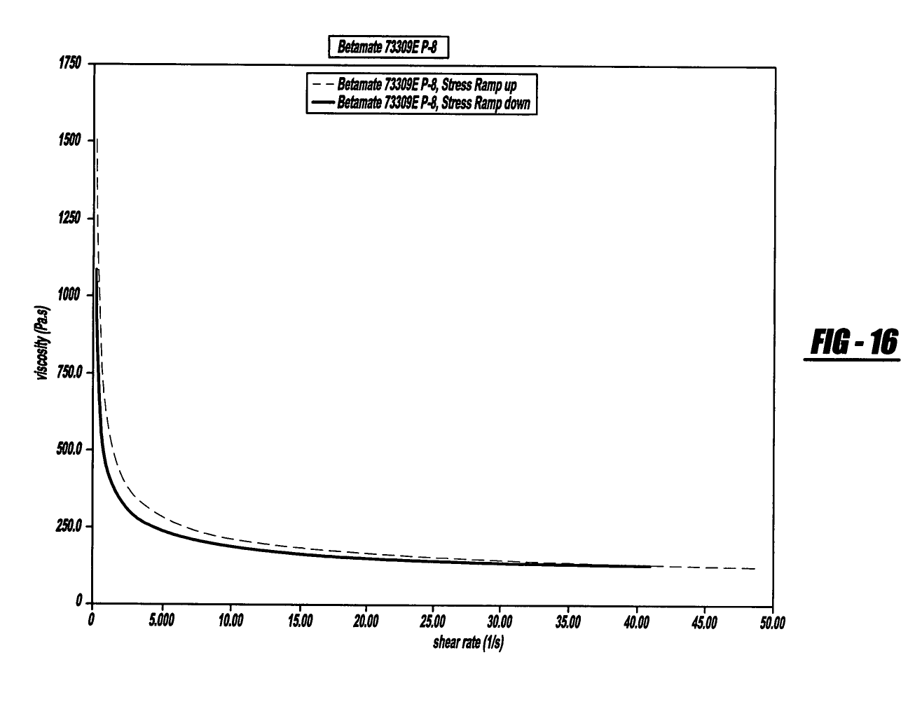

Referring to FIG. 16, there is shown a graphical view of the viscosity characteristics of an eighth batch (P-8) of a one-part epoxy adhesive composition of the present invention, in accordance with a sixteenth embodiment of the present invention.

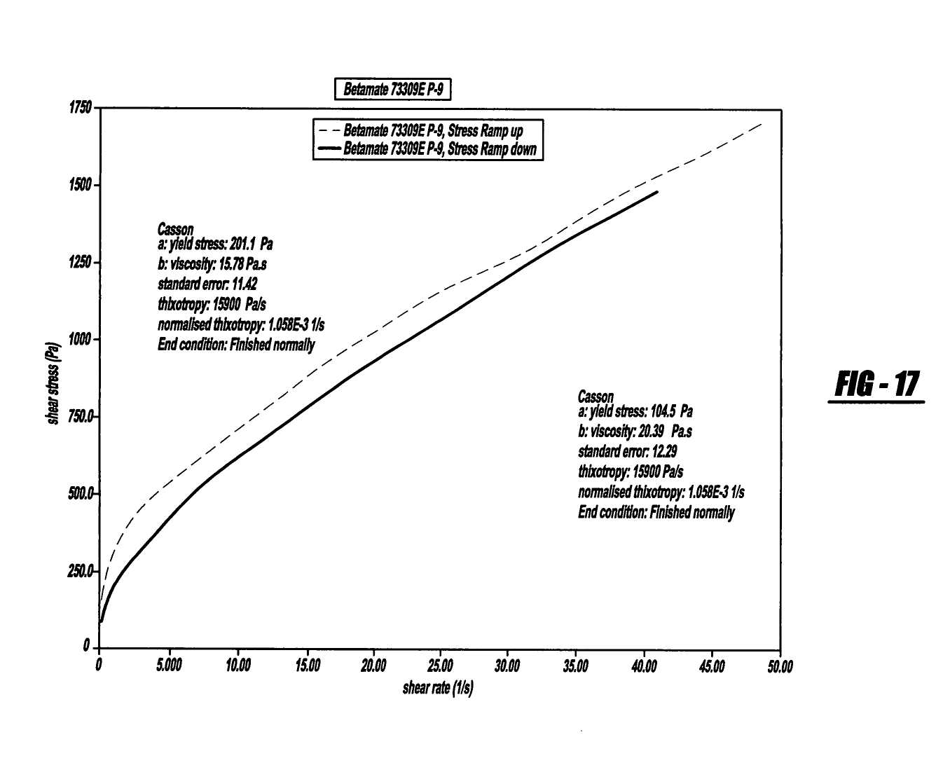

Referring to FIG. 17, there is shown a graphical view of the shear stress characteristics of a ninth batch (P-9) of a one-part epoxy adhesive composition of the present invention, in accordance with a seventeenth embodiment of the present invention.

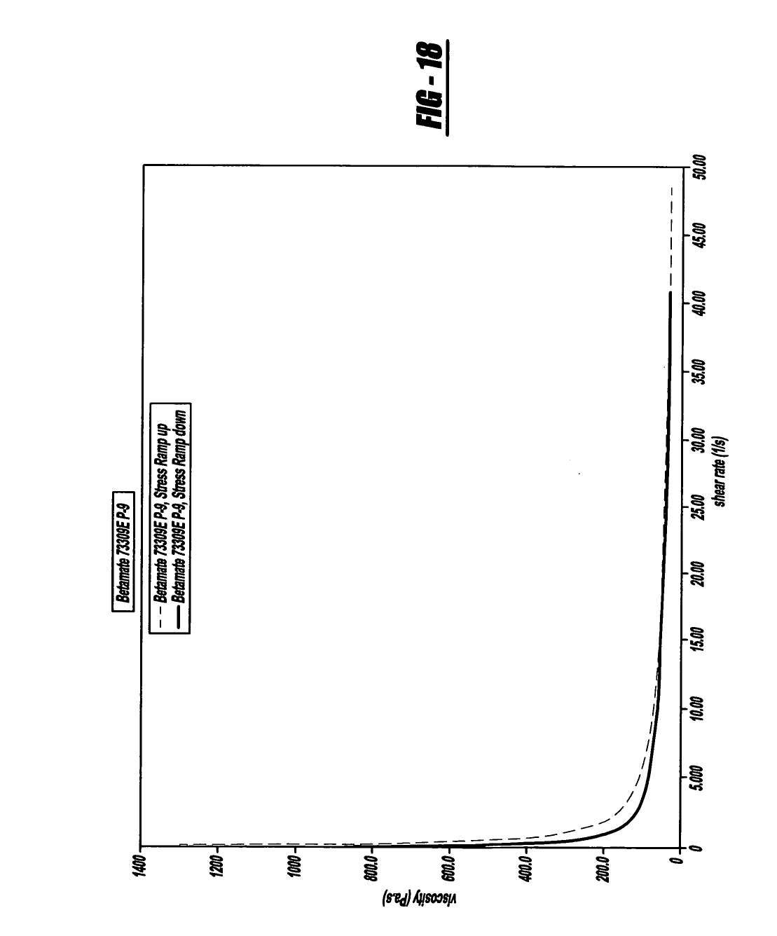

Referring to FIG. 18, there is shown a graphical view of the viscosity characteristics of a ninth batch (P-9) of a one-part epoxy adhesive composition of the present invention, in accordance with an eighteenth embodiment of the present invention.

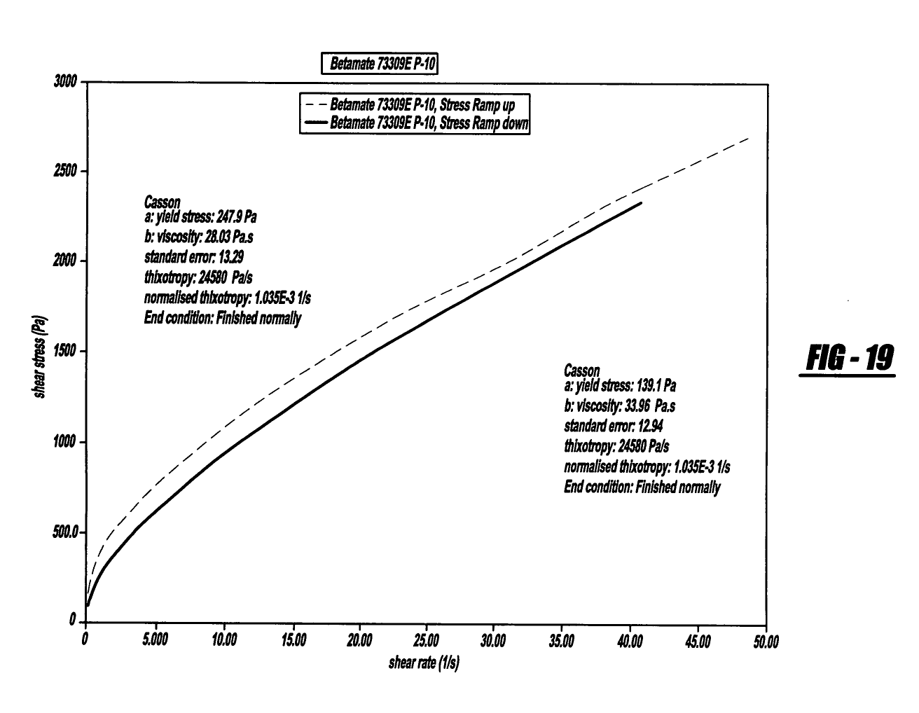

Referring to FIG. 19, there is shown a graphical view of the shear stress characteristics of a tenth batch (P-10) of a one-part epoxy adhesive composition of the present invention, in accordance with a nineteenth embodiment of the present invention.

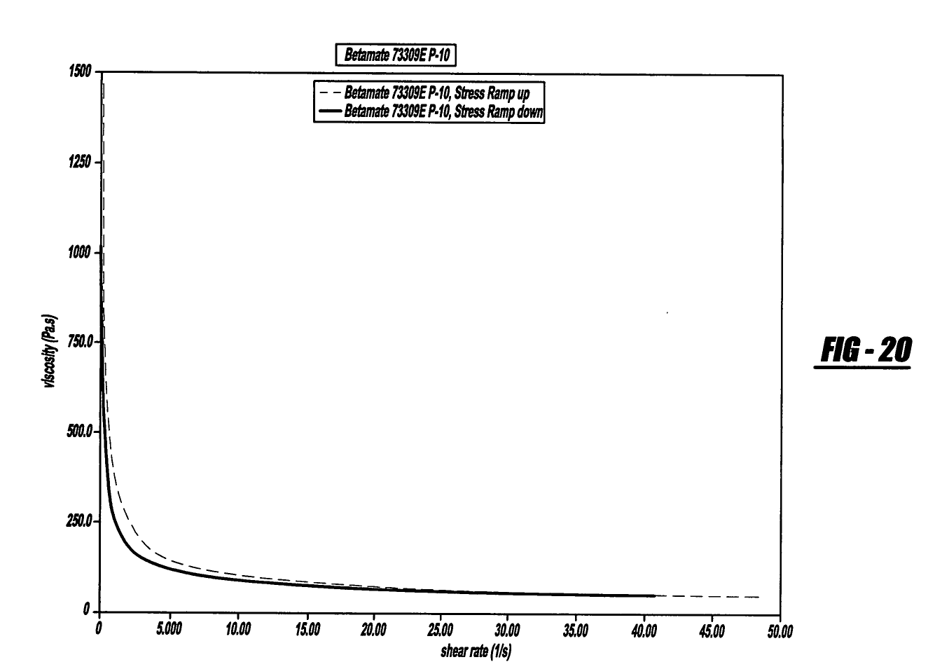

Referring to FIG. 20, there is shown a graphical view of the viscosity characteristics of a tenth batch (P-10) of a one-part epoxy adhesive composition of the present invention, in accordance with a twentieth embodiment of the present invention.

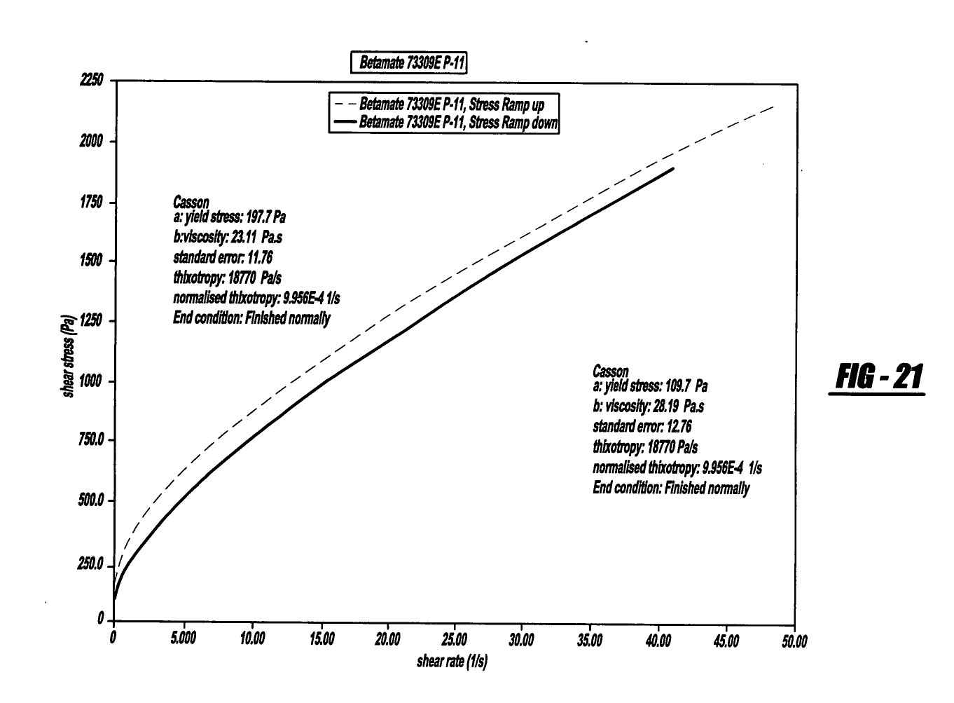

Referring to FIG. 21, there is shown a graphical view of the shear stress characteristics of an eleventh batch (P-11) of a one-part epoxy adhesive composition of the present invention, in accordance with a twenty-first embodiment of the present invention.

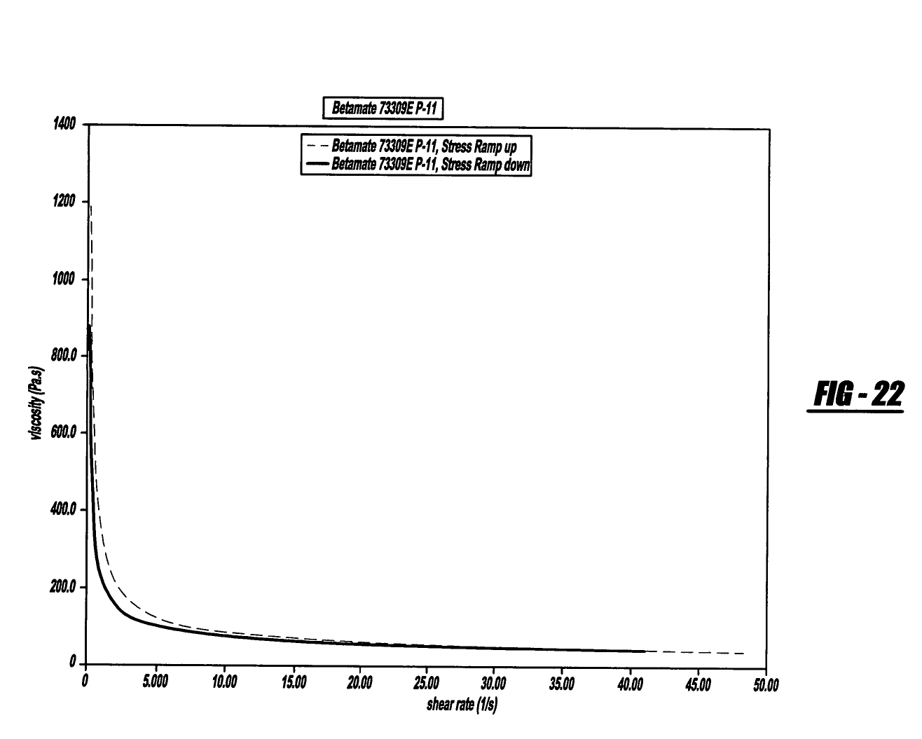

Referring to FIG. 22, there is shown a graphical view of the viscosity characteristics of an eleventh batch (P-11) of a one-part epoxy adhesive composition of the present invention, in accordance with a twenty-second embodiment of the present invention.

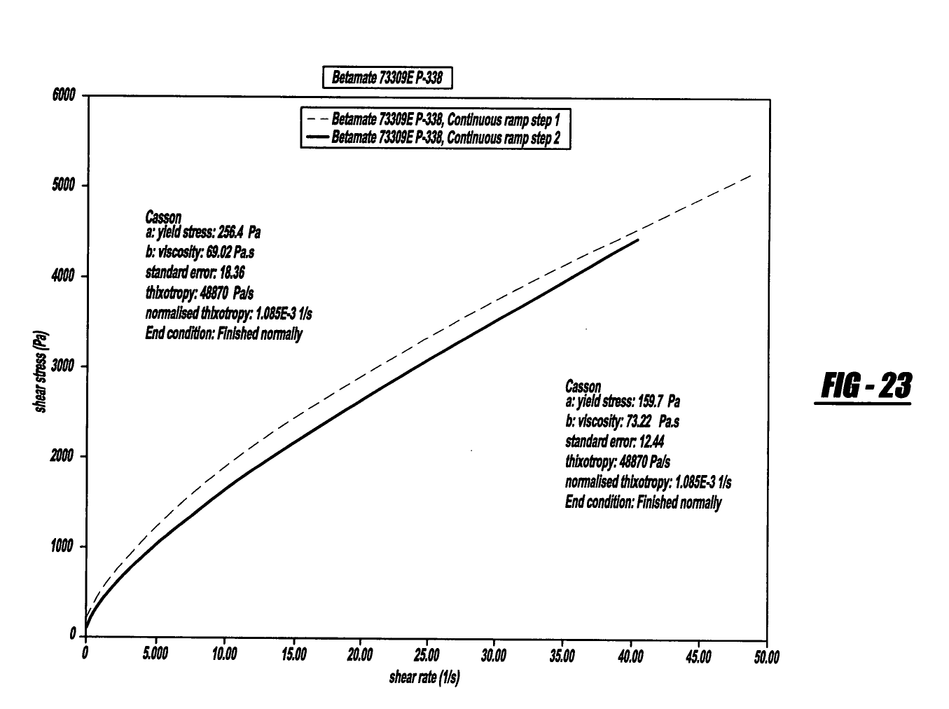

Referring to FIG. 23, there is shown a graphical view of the shear stress characteristics of a twelfth batch (338) of a one-part epoxy adhesive composition of the present invention, in accordance with a twenty-third embodiment of the present invention.

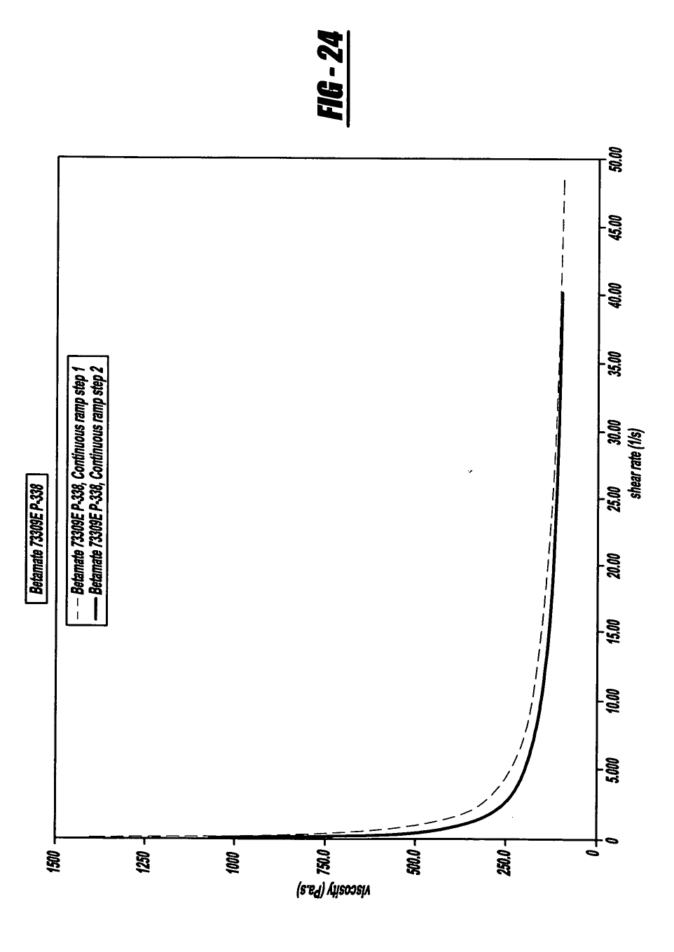

Referring to FIG. 24, there is shown a graphical view of the viscosity characteristics of a twelfth batch (338) of a one-part epoxy adhesive composition of the present invention, in accordance with a twenty-fourth embodiment of the present invention.

The shear and viscosity characteristics of the various batches of the one-part epoxy adhesive compositions of the present invention depicted in FIGS. 1-24, illustrate the benefits of employing pulp fibers, such as but not limited to amine-based materials (e.g., aramid fibers), and impact modifiers, such as but not limited to methacrylate butadiene styrene copolymer, carboxyl terminated butadiene/acrylonitrile copolymer, and combinations thereof.

Furthermore, the physical and mechanical properties of the one-part epoxy adhesive compositions of the present invention are similar to the properties of conventional adhesives, such as crash durable adhesives (CDA) and semi-crash durable adhesives (SDA).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A one-part epoxy adhesive formulation, comprising:
a fiber pulp, wherein the fiber pulp is comprised of an amine-based material; and
an impact modifier, wherein the impact modifier is comprised of a material selected from the group consisting of methacrylate butadiene styrene copolymer, carboxyl terminated butadiene/acrylonitrile copolymer, and combinations thereof.

2. The invention according to claim 1, wherein the fiber pulp is present in an amount in the range of about 0.4 to about 2 weight percent based on the total weight of the one-part epoxy adhesive formulation.

3. The invention according to claim 1, wherein the fiber pulp is present in an amount in the range of about 0.8 to about 1.6 weight percent based on the total weight of the one-part epoxy adhesive formulation.

4. The invention according to claim 1, wherein the fiber pulp is present in an amount in the range of about 1 to about 1.4 weight percent based on the total weight of the one-part epoxy adhesive formulation.

5. The invention according to claim 1, wherein the impact modifier is present in an amount in the range of about 5 to about 16 weight percent based on the total weight of the one-part epoxy adhesive formulation.

6. The invention according to claim 1, wherein the impact modifier is present in an amount in the range of about 9 to about 15 weight percent based on the total weight of the one-part epoxy adhesive formulation.

7. The invention according to claim 1, wherein the impact modifier is present in an amount in the range of about 11 to about 13 weight percent based on the total weight of the one-part epoxy adhesive formulation.

8. The invention according to claim 1, wherein the fiber pulp has a fiber length in the range of about 0.85 to about 1.35 mm.

9. The invention according to claim 1, wherein the fiber pulp includes an aspect ratio in the range of about 65 to about 100.

10. The invention according to claim 1, wherein the fiber pulp includes a specific surface area in the range of about 12 to about 15 m²/g.

11. A one-part epoxy adhesive formulation, comprising:
a fiber pulp, wherein the fiber pulp is comprised of an aramid-based material; and
an impact modifier, wherein the impact modifier is comprised of a material selected from the group consisting of methacrylate butadiene styrene copolymer, carboxyl terminated butadiene/acrylonitrile copolymer, and combinations thereof.

12. The invention according to claim 11, wherein the fiber pulp is present in an amount in the range of about 0.4 to about 2 weight percent based on the total weight of the one-part epoxy adhesive formulation.

13. The invention according to claim 11, wherein the fiber pulp is present in an amount in the range of about 0.8 to about 1.6 weight percent based on the total weight of the one-part epoxy adhesive formulation.

14. The invention according to claim 11, wherein the fiber pulp is present in an amount in the range of about 1 to about 1.4 weight percent based on the total weight of the one-part epoxy adhesive formulation.

15. The invention according to claim 11, wherein the impact modifier is present in an amount in the range of about 5 to about 16 weight percent based on the total weight of the one-part epoxy adhesive formulation.

16. The invention according to claim 11, wherein the impact modifier is present in an amount in the range of about 9 to about 15 weight percent based on the total weight of the one-part epoxy adhesive formulation.

17. The invention according to claim 11, wherein the impact modifier is present in an amount in the range of about 11 to about 13 weight percent based on the total weight of the one-part epoxy adhesive formulation.

18. The invention according to claim 11, wherein the fiber pulp has a fiber length in the range of about 0.85 to about 1.35 mm.

19. The invention according to claim 11, wherein the fiber pulp includes an aspect ratio in the range of about 65 to about 100.

20. The invention according to claim 11, wherein the fiber pulp includes a specific surface area in the range of about 12 to about 15 m²/g.

21. A one-part epoxy adhesive formulation, comprising:
a fiber pulp, wherein the fiber pulp is comprised of an aramid-based material, wherein the fiber pulp is present in an amount in the range of about 0.4 to about 2 weight percent based on the total weight of the one-part epoxy adhesive formulation; and
an impact modifier, wherein the impact modifier is comprised of a material selected from the group consisting of methacrylate butadiene styrene copolymer, carboxyl terminated butadiene/acrylonitrile copolymer, and combinations thereof, wherein the impact modifier is present in an amount in the range of about 5 to about 16 weight percent based on the total weight of the one-part epoxy adhesive formulation.

22. The invention according to claim 21, wherein the fiber pulp is present in an amount in the range of about 0.8 to about 1.6 weight percent based on the total weight of the one-part epoxy adhesive formulation.

23. The invention according to claim 21, wherein the fiber pulp is present in an amount in the range of about 1 to about 1.4 weight percent based on the total weight of the one-part epoxy adhesive formulation.

24. The invention according to claim 21, wherein the impact modifier is present in an amount in the range of about 9 to about 15 weight percent based on the total weight of the one-part epoxy adhesive formulation.

25. The invention according to claim 21, wherein the impact modifier is present in an amount in the range of about 11 to about 13 weight percent based on the total weight of the one-part epoxy adhesive formulation.

26. The invention according to claim 21, wherein the fiber pulp has a fiber length in the range of about 0.85 to about 1.35 mm.

27. The invention according to claim 21, wherein the fiber pulp includes an aspect ratio in the range of about 65 to about 100.

28. The invention according to claim 21, wherein the fiber pulp includes a specific surface area in the range of about 12 to about 15 m²/g.
